(19) United States
(12) Patent Application Publication
(10) Pub. No.: US 2021/0082195 A1
(43) Pub. Date: Mar. 18, 2021

(54) SYSTEMS AND METHODS FOR PROVIDING VIRTUAL ELEMENTS BASED ON A CODE PROVIDED WITHIN A MIXED REALITY SCENE

(71) Applicant: IGT, Las Vegas, NV (US)

(72) Inventors: Michael RUSS, Graz (AT); Sven AURICH, Schwanberg (AT); Stefan KEILWERT, St. Josef (AT); David FROY, Lakeville-Westmorland (CA)

(21) Appl. No.: 17/033,361

(22) Filed: Sep. 25, 2020

Related U.S. Application Data
(63) Continuation of application No. 16/054,427, filed on Aug. 3, 2018, now abandoned.

(51) Int. Cl. G06T 19/00; G06T 19/20; H04W 4/02; G06K 7/14; G07F 17/34

(52) U.S. Cl. CPC G06T 19/006; G06T 19/20; G07F 17/34; G06K 7/1417; H04W 4/025

(57) ABSTRACT

Mixed reality systems and methods, and in particular to systems and methods for providing virtual elements based on a code provided within a mixed reality scene, are provided. A mixed reality method includes generating a live video signal of a scene associated with a field of view of a user, wherein the scene comprises an optical, machine-readable representation of code data. The method further includes determining, via a processing device, the code data based on the representation of the code data. The method further includes determining, via the processing device based on the code data, a virtual element in real time. The method further includes displaying the virtual element to the user as part of the scene.

### BACKGROUND

Embodiments described herein relate to mixed reality systems and methods, and in particular to systems and methods for providing virtual elements based on a code provided within a mixed reality scene. Electronic and electro-mechanical gaming machines (EGMs) are systems that allow users to place a wager on the outcome of a random event, such as the spinning of mechanical or virtual reels or wheels, the playing of virtual cards, the rolling of mechanical or virtual dice, the random placement of tiles on a screen, etc. Manufacturers of EGMs have incorporated a number of enhancements to the EGMs to allow players to interact with the EGMs in new and more engaging ways. For example, early slot machines allowed player interaction by pulling a lever or arm on the machine. As mechanical slot machines were replaced by electronic slot machines, a range of new player interface devices became available to EGM designers and were subsequently incorporated into EGMs. Examples of such interface devices include electronic buttons, wheels, and, more recently, touchscreens and three-dimensional display screens.

### BRIEF SUMMARY

Embodiments described herein relate to mixed reality systems and methods, and in particular to systems and methods for providing virtual elements based on a code provided within a mixed reality scene. According to some embodiments, a method is disclosed. The method includes generating a live video signal of a scene associated with a field of view of a user, wherein the scene comprises an optical, machine-readable representation of code data. The method further includes determining, via a processing device, the code data based on the representation of the code data. The method further includes determining, via the processing device based on the code data, a virtual element in real time. The method further includes displaying the virtual element to the user as part of the scene.

According to other embodiments, a mixed reality device is disclosed. The mixed reality device includes a display device, a video capture device, a processor, and a memory coupled to the processor. The memory includes machine-readable instructions operable to cause the processor to generate, via the video capture device, a live video signal of a scene associated with a field of view of a user, wherein the scene comprises an optical, machine-readable representation of code data. The memory further includes machine-readable instructions operable to cause the processor to determine the code data based on the representation of the code data. The memory further includes machine-readable instructions operable to cause the processor to determine, based on the code data, a virtual element in real time. The memory further includes machine-readable instructions operable to cause the processor to display, via the display device, the virtual element to the user as part of the scene.

According to other embodiments, a method is disclosed. The method includes receiving a data request message from an augmented reality device, the data request message generated by the augmented reality device in response to the augmented reality device determining code data based on an optical, machine-readable representation of code data. The method further includes determining a location of the augmented reality device. The method further includes providing virtual element data to the augmented reality device for displaying a virtual element to a user of the augmented reality device as part of a scene associated with a field of view of the user.

### BRIEF DESCRIPTION OF THE DRAWINGS

FIG. 1 is a schematic block diagram illustrating a network configuration for a plurality of gaming devices according to some embodiments.

FIGS. 2A to 2D illustrate mixed reality viewers according to various embodiments.

FIG. 3A is a map of a gaming area, such as a casino floor.

FIG. 3B is a 3D wireframe model of the gaming area of FIG. 3A.

FIG. 4 illustrates a mixed reality interface including a sign within the scene having a code for providing virtual elements, according to some embodiments.

FIG. 5 illustrates a mixed reality interface including a vehicle within the scene having a code for providing virtual elements, according to some embodiments.

FIG. 6 illustrates a mixed reality interface including a printed medium within the scene having a code for providing virtual elements, according to some embodiments.

FIG. 7 illustrates a mixed reality interface including a mobile device within the scene having a code for providing virtual elements, according to some embodiments.

FIG. 8A-8C illustrate different examples of codes for providing virtual elements within a mixed reality interface, according to some embodiments.

FIG. 9 is a flowchart illustrating operations of systems/methods according to some embodiments.

FIG. 10A is a perspective view of an electronic gaming device that can be configured according to some embodiments.

FIG. 10B is a schematic block diagram illustrating an electronic configuration for a gaming device according to some embodiments.

FIG. 10C is a block diagram that illustrates various functional modules of an electronic gaming device according to some embodiments.

FIG. 10D is perspective view of a handheld electronic gaming device that can be configured according to some embodiments.

FIG. 10E is a perspective view of an electronic gaming device according to further embodiments.

FIG. 11 is a schematic block diagram illustrating an electronic configuration for a mixed reality controller according to some embodiments.

FIG. 12 is a flowchart illustrating operations of systems/methods according to some embodiments.

### DETAILED DESCRIPTION

Embodiments described herein relate to mixed reality systems and methods, and in particular to systems and methods for providing virtual elements based on a code provided within a mixed reality scene. According to some embodiments, a method is disclosed. The method includes generating a live video signal of a scene associated with a field of view of a user, wherein the scene comprises an optical, machine-readable representation of code data. The method further includes determining, via a processing device, the code data based on the representation of the code data. The method further includes determining, via the processing device based on the code data, a virtual element in real time. The method further includes displaying the virtual element to the user as part of the scene.

Advantages of these and other embodiments include the ability to trigger the display of mixed reality content (which may also be referred to herein as augmented reality (AR) content) in real-time based on the contents of a live video signal without expending an unnecessary amount of power or computing overhead. One technical problem with some conventional mixed reality applications is that an entire scene may need to be analyzed continuously and in real-time in order to determine whether mixed reality content should be provided, which increases power consumption and computing overhead for the mixed reality device. This problem may be exacerbated by the need to conserve battery life for the mixed reality device. One technical solution to this problem is to only analyze elements of the scene that correspond to a relatively simple machine-readable representation of code data, such as a bar code or logo, effectively ignoring the other elements of the scene and conserving computing overhead and battery life for the mixed reality device.

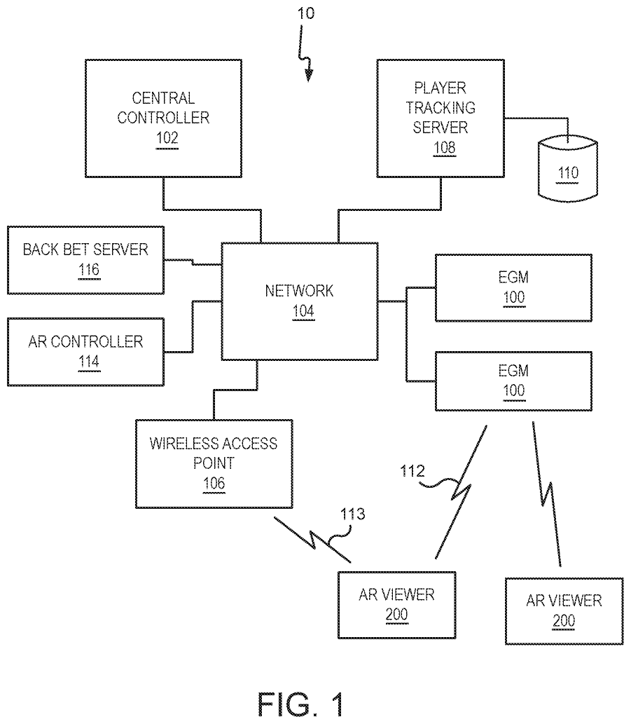

Referring to FIG. 1, a gaming system 10 including a plurality of EGMs 100 is illustrated. The gaming system 10 may be located, for example, on the premises of a gaming establishment, such as a casino. The EGMs 100, which are typically situated on a casino floor, may be in communication with each other and/or at least one central controller 102 through a data network or remote communication link 104. The data communication network 104 may be a private data communication network that is operated, for example, by the gaming facility that operates the EGM 100. Communications over the data communication network 104 may be encrypted for security. The central controller 102 may be any suitable server or computing device which includes at least one processor and at least one memory or storage device. Each EGM 100 may include a processor that transmits and receives events, messages, commands or any other suitable data or signal between the EGM 100 and the central controller 102. The EGM processor is operable to execute such communicated events, messages or commands in conjunction with the operation of the EGM. Moreover, the processor of the central controller 102 is configured to transmit and receive events, messages, commands or any other suitable data or signal between the central controller 102 and each of the individual EGMs 100. In some embodiments, one or more of the functions of the central controller 102 may be performed by one or more EGM processors. Moreover, in some embodiments, one or more of the functions of one or more EGM processors as disclosed herein may be performed by the central controller 102.

A wireless access point 106 provides wireless access to the data communication network 104. The wireless access point 106 may be connected to the data communication network 104 as illustrated in FIG. 1, or may be connected directly to the central controller 102 or another server connected to the data communication network 104.

A player tracking server 108 may also be connected through the data communication network 104. The player tracking server 108 may manage a player tracking account that tracks the player's gameplay and spending and/or other player preferences and customizations, manages loyalty awards for the player, manages funds deposited or advanced on behalf of the player, and other functions. Player information managed by the player tracking server 108 may be stored in a player information database 110.

As further illustrated in FIG. 1, a mixed reality viewer 200, or augmented reality (AR) viewer, is provided. The mixed reality viewer 200 communicates with one or more elements of the system 10 to render two-dimensional (2D) and/or three-dimensional (3D) content to a player of one of the EGMs 100 in a virtual space, while at the same time allowing the player to see objects in the real space around the player. That is, the mixed reality viewer 200 combines a virtual image with real images perceived by the user, including images of real objects as well as images displayed by the EGM 100. In this manner, the mixed reality viewer 200 “mixes” real and virtual reality into a single viewing experience for the player. In some embodiments, the mixed reality viewer 200 may be further configured to enable the player to interact with both the real and virtual objects displayed to the player by the mixed reality viewer 200.

The mixed reality viewer 200 communicates with one or more elements of the system 10 to coordinate the rendering of mixed reality images, and in some embodiments mixed reality 3D images, to the player. For example, in some embodiments, the mixed reality viewer 200 may communicate directly with an EGM 100 over a wireless interface 112, which may be a WiFi link, a Bluetooth link, an NFC link, etc. In other embodiments, the mixed reality viewer 200 may communicate with the data communication network 104 (and devices connected thereto, including EGMs) over a wireless interface 113 with the wireless access point 106. The wireless interface 113 may include a WiFi link, a Bluetooth link, an NFC link, etc. In still further embodiments, the mixed reality viewer 200 may communicate simultaneously with both the EGM 100 over the wireless interface 112 and the wireless access point 106 over the wireless interface 113. In these embodiments, the wireless interface 112 and the wireless interface 113 may use different communication protocols and/or different communication resources, such as different frequencies, time slots, spreading codes, etc. For example, in some embodiments, the wireless interface 112 may be a Bluetooth link, while the wireless interface 113 may be a WiFi link.

The wireless interfaces 112, 113 allow the mixed reality viewer 200 to coordinate the generation and rendering of mixed reality images to the player via the mixed reality viewer 200.

In some embodiments, the gaming system 10 includes a mixed reality controller, or AR controller 114. The AR controller 114 may be a computing system that communicates through the data communication network 104 with the EGMs 100 and the mixed reality viewers 200 to coordinate the generation and rendering of virtual images to one or more players using the mixed reality viewers 200. The AR controller 114 may be implemented within or separately from the central controller 102.

In some embodiments, the AR controller 114 may coordinate the generation and display of the virtual images of the same virtual object to more than one player by more than one mixed reality viewer 200. As described in more detail below, this may enable multiple players to interact with the same virtual object together in real time. This feature can be used to provide a shared multiplayer experience to multiple players at the same time.

Moreover, in some embodiments, the AR controller 114 may coordinate the generation and display of the same virtual object to players at different physical locations, as will be described in more detail below.

The AR controller 114 may store a three-dimensional wireframe map of a gaming area, such as a casino floor, and may provide the three-dimensional wireframe map to the mixed reality viewers 200. The wireframe map may store various information about EGMs in the gaming area, such as the identity, type and location of various types of EGMs. The three-dimensional wireframe map may enable a mixed reality viewer 200 to more quickly and accurately determine its position and/or orientation within the gaming area, and also may enable the mixed reality viewer 200 to assist the player in navigating the gaming area while using the mixed reality viewer 200. The generation of three-dimensional wireframe maps is described in more detail below.

In some embodiments, at least some processing of virtual images and/or objects that are rendered by the mixed reality viewers 200 may be performed by the AR controller 114, thereby offloading at least some processing requirements from the mixed reality viewers 200.

A back bet server 116 may be provided to manage back bets placed using a mixed reality viewer 200 as described in more detail below. A mixed reality viewer 200 may communicate with the back bet server 116 through the wireless interface 113 and network 104.

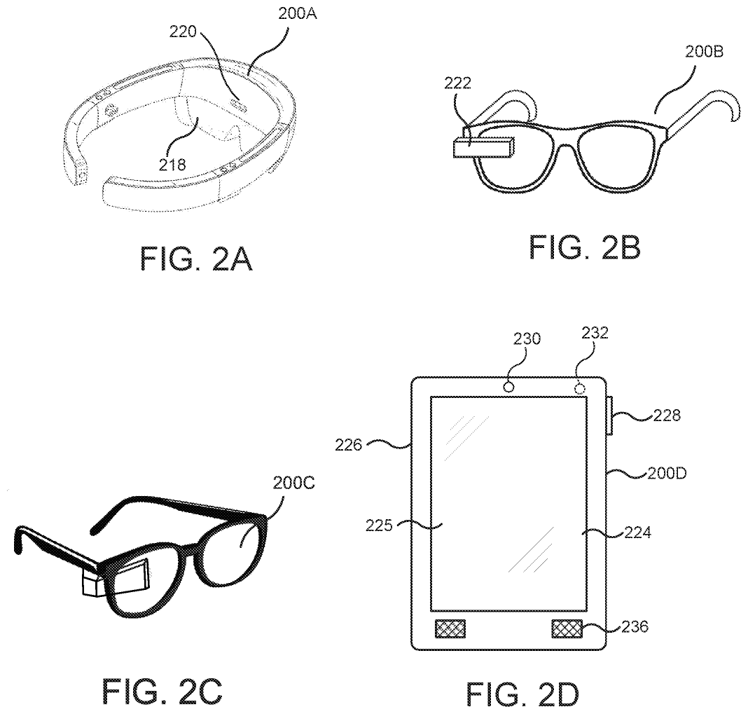

Referring to FIGS. 2A to 2D, the mixed reality viewer 200 may be implemented in a number of different ways. For example, referring to FIG. 2A. in some embodiments, a mixed reality viewer 200A may be implemented as a 3D headset including a pair of semitransparent lenses 218 on which images of virtual objects may be displayed. Different stereoscopic images may be displayed on the lenses 218 to create an appearance of depth, while the semitransparent nature of the lenses 218 allow the user to see both the real world as well as the 3D image rendered on the lenses 218. The mixed reality viewer 200A may be implemented, for example, using a Hololens' from Microsoft Corporation. The Microsoft Hololens includes a plurality of cameras and other sensors 220 that the device uses to obtain a live video signal for building a 3D model of the space around the user. The device 200A can generate a 3D image to display to the user that takes into account the real world objects around the user and allows the user to interact with the 3D object.

The device 200A may further include other sensors, such as a gyroscopic sensor, a GPS sensor, one or more accelerometers, and/or other sensors that allow the device 200A to determine its position and orientation in space. In further embodiments, the device 200A may include one or more cameras that allow the device 200A to determine its position and/or orientation in space using visual simultaneous localization and mapping (VSLAM). The device 200A may further include one or more microphones and/or speakers that allow the user to interact audially with the device.

Referring to FIG. 2B, a mixed reality viewer 200B may be implemented as a pair of glasses including a transparent prismatic display 222 that displays an image to a single eye of the user. An example of such a device is the Google Glass device. Such a device may be capable of displaying images to the user while allowing the user to see the world around the user, and as such can be used as a mixed reality viewer. However, it will be appreciated that the device 200B may be incapable of displaying 3D images to the user.

In other embodiments, referring to FIG. 2C, the mixed reality viewer may be implemented using a virtual retinal display device 200C. In contrast to devices that display an image within the field of view of the user, a virtual retinal display raster scans an image directly onto the retina of the user. Like the device 200B, the virtual retinal display device 200C combines the displayed image with surrounding light to allow the user to see both the real world and the displayed image. However, also like the device 200B, the virtual retinal display device 200C may be incapable of displaying 3D images to the user.

In still further embodiments, a mixed reality viewer 200D may be implemented using a mobile wireless device, such as a mobile telephone, a tablet computing device, a personal digital assistant, or the like. The device 200D may be a handheld device including a housing 226 on which a touchscreen display device 224 including a digitizer 225 is provided. An input button 228 may be provided on the housing and may act as a power or control button. A rear facing camera 230 may be provided in a front face of the housing 226. The device 200D may further include a front facing camera 232 on a rear face of the housing 226. The device 200D may include one or more speakers 236 and a microphone 234. The device 200D may provide a mixed reality display by capturing a video signal using the front facing camera 232 and displaying the video signal on the display device 224, and also displaying a rendered image of a virtual object over the captured video signal. In this manner, the user may see both a mixed image of both a real object in front of the device 200D as well as a virtual object superimposed over the real object to provide a mixed reality viewing experience.

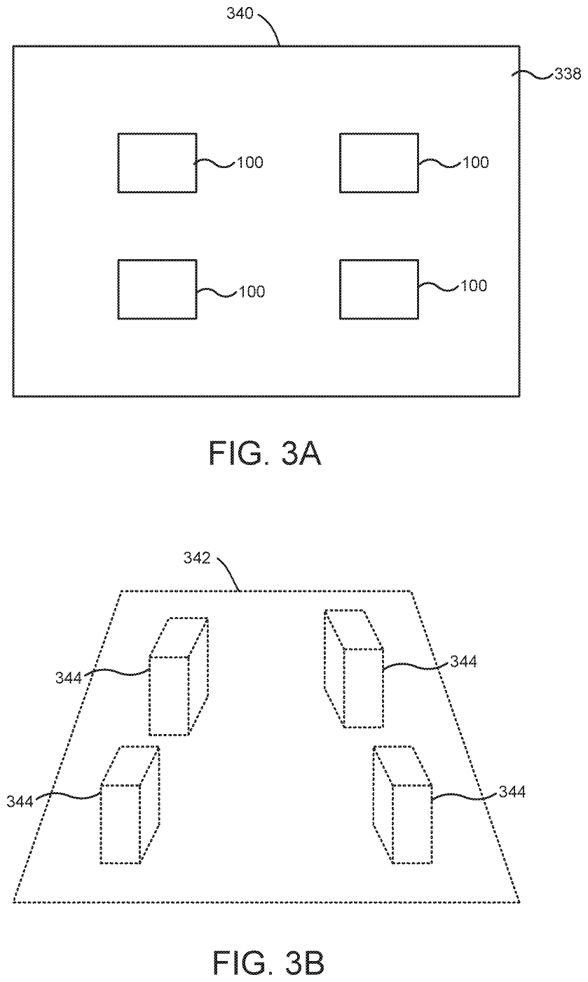

FIG. 3A illustrates, in plan view, an example map 338 of a gaming area 340. The gaming area 340 may, for example, be a casino floor. The map 338 shows the location of a plurality of EGMs 100 within the gaming area 340, but it should be understood that the map 338 may correspond to any representative area, including areas in and around a casino property, or outdoor areas in a city or town where the casino is located, for example. As noted above, in order to assist the operation of the mixed reality viewers 200, the AR controller 114 may store a three-dimensional wireframe map of the gaming area 340 or other area, and may provide the three-dimensional wireframe map to the mixed reality viewers 200.

An example of a wireframe map 342 is shown in FIG. 3B. The wireframe map 342 is a three-dimensional model of the gaming area 340. As shown in FIG. 3B, the wireframe map 342 includes wireframe models 344 corresponding to the EGMs 100 or other devices, fixtures, or architectural features that are physically in the gaming area 340 or other area. The wireframe models 344 may be pregenerated to correspond to various form factors. The pregenerated models may then be placed into the wireframe map, for example, by a designer or other personnel. The wireframe map 342 may be updated whenever the physical location of EGMs or other devices or fixtures in the gaming area 340 or other area are changed.

In some embodiments, the wireframe map 342 may be generated automatically using a mixed reality viewer 200, such as a 3D headset, that is configured to perform a three-dimensional depth scan of its surroundings and generate a three-dimensional model based on the scan results. Thus, for example, an operator using a mixed reality viewer 200A (FIG. 2A) may perform a walkthrough of the gaming area 340 or other area while the mixed reality viewer 200A builds the 3D map of the area.

The three-dimensional wireframe map 342 may enable a mixed reality viewer 200 to more quickly and accurately determine its position and/or orientation within the gaming area 340 or other area. For example, a mixed reality viewer 200 may determine its location within the gaming area 340 or other area using one or more position/orientation sensors. The mixed reality viewer 200 then builds a three-dimensional map of its surroundings using depth scanning, and compares its sensed location relative to objects within the generated three-dimensional map with an expected location based on the location of corresponding objects within the wireframe map 342. The mixed reality viewer 200 may calibrate or refine its position/orientation determination by comparing the sensed position of objects with the expected position of objects based on the wireframe map 342. Moreover, because the mixed reality viewer 200 has access to the wireframe map 342 of the entire gaming area 340 or other area, the mixed reality viewer 200 can be aware of objects or destinations within the gaming area 340 or other area that it has not itself scanned. Processing requirements on the mixed reality viewer 200 may also be reduced because the wireframe map 342 is already available to the mixed reality viewer 200.

In some embodiments, the wireframe map 342 may store various information about EGMs in the gaming area 340 or other area, such as the identity, type, orientation and location of various types of EGMs, the locations of exits, bathrooms, courtesy desks, cashiers, ATMs, ticket redemption machines, etc., for example. Such information may be used by a mixed reality viewer 200 to help the user navigate the gaming area 340 or other area. For example, if a user desires to find a destination within the gaming area, the user may ask the mixed reality viewer 200 for directions using a built-in microphone and voice recognition function in the mixed reality viewer 200 or use other hand gestures or eye/gaze controls tracked by the mixed reality viewer 200 (instead of or in addition to voice control). The mixed reality viewer 200 may process the request to identify the destination, and then may display a virtual object, such as a virtual path on the ground, virtual arrow, virtual sign, etc., to help the user to find the destination. In some embodiments, for example, the mixed reality viewer 200 may display a halo or glow around the destination to highlight it for the user, or have virtual 3D sounds coming from it so players could more easily find the machine.

According to some embodiments, a user of a mixed reality viewer 200 may use the mixed reality viewer 200 to obtain information about players and/or EGMs on a casino gaming floor. The information may be displayed to the user on the mixed reality viewer 200 in a number of different ways such as by displaying images on the mixed reality viewer 200 that appear to be three-dimensional or two-dimensional elements of the scene as viewed through the mixed reality viewer 200. In general, the type and/or amount of data that is displayed to the user may depend on what type of user is using the mixed reality viewer 200 and, correspondingly, what level of permissions or access the user has.

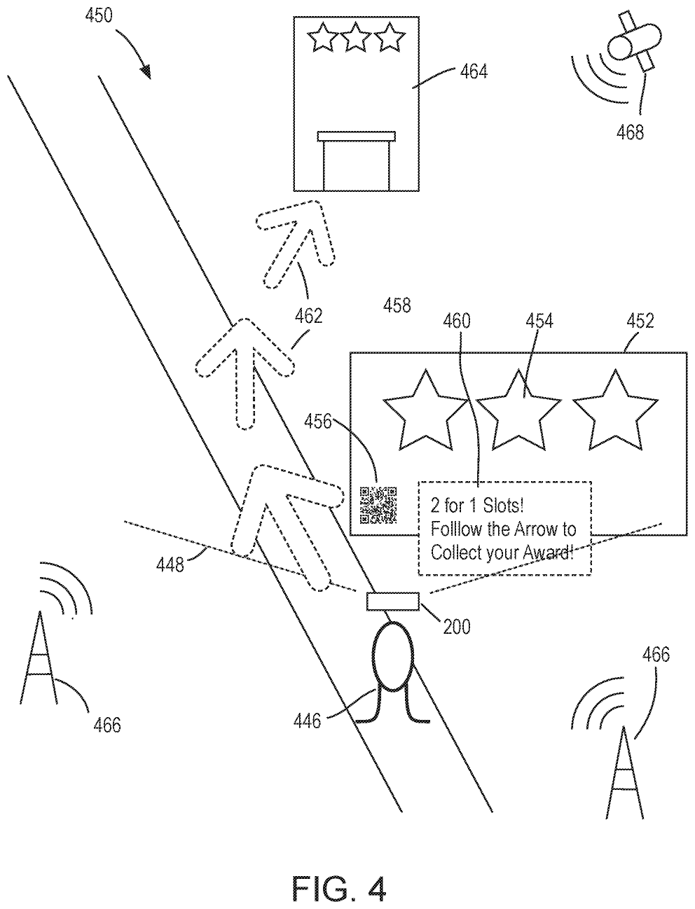

Referring now to FIG. 4, a mixed reality interface including a sign within a scene having a code for providing virtual elements is illustrated, according to some embodiments. In this example, a user 446 is viewing a scene 448 using a mixed reality viewer 200, which provides a mixed reality interface 450 to the user 446 having real-world and virtual elements within the scene 448. In this example, the scene includes a real-world sign 452, such as a billboard, that contains informational elements 454, such as graphics or text, and a code 456. In this embodiment, the code 456 is an optical, machine-readable representation of code data. More specifically, the code 456 in this embodiment is a two-dimensional matrix bar code, such as a quick response code (i.e., QR code), for example. It should be understood, however, that other types of codes may be used, such as one-dimensional bar codes, i.e., universal product codes (UPCs), or other types of codes that may be detected within the scene 448. The code 456 may also include a set of codes within a single representation of code data, thereby allowing the mixed reality viewer to determine multiple discrete codes while only analyzing a single overall code 456, which may reduce computing overhead further.

The code 456 may be detected and identified within the scene 448 in a number of ways, such as through the mixed reality viewer 200, for example. The code data is determined based on the code 456, and, based on the code data, the one or more virtual elements 458 are displayed to the user 446 in real time as part of the scene 448. In this example, the virtual elements 458 include a casino offer 460 indicating a benefit associated with visiting a casino 464 or other location, and a graphical arrow 462 indicating a direction toward the casino 464 or other location where the user can redeem the offer 460.

In some embodiments, determining and displaying the virtual elements 458 includes determining a location of the user 446 in relation to the casino 464 and or other landmarks in or proximate to the scene 448. In some embodiments, the code 456 may be at a known location, such as a stationary or non-stationary representation on a stationary sign 452 or billboard for example. In some embodiments, however, additional information may be required to determine the location of the user 446 relative to the casino 464 or other landmarks. In this example, the mixed reality viewer may wirelessly communicate with and/or detect signals from one or more wireless antennas, e.g., ground based antennas 466 and/or global positioning system (GPS) satellites 468, to determine location information indicative of the location of the user 446 of the mixed reality viewer 200. For example, the mixed reality viewer 200 may determine its location by determining a distance between the mixed reality viewer 200 and the ground based antennas 466 and/or GPS satellites 468 to triangulate its location. In other embodiments, the mixed reality viewer 200 may determine its location based on the known locations of other real-world elements that are visible within the scene 448 via a video signal of the mixed reality viewer 200. As part of this communication with the ground based antennas 466, the mixed reality viewer 200 may also exchange code-related data, such as determining whether the mixed reality viewer 200 is eligible to scan the code, for example.

The sign 452 in this example may include stationary, printed graphics including the code 456 or may include an electronic display device (e.g., a digital sign) for displaying static or non-stationary, e.g., animated, graphics including the code 456. It should also be understood that codes may be provided in other ways as well.

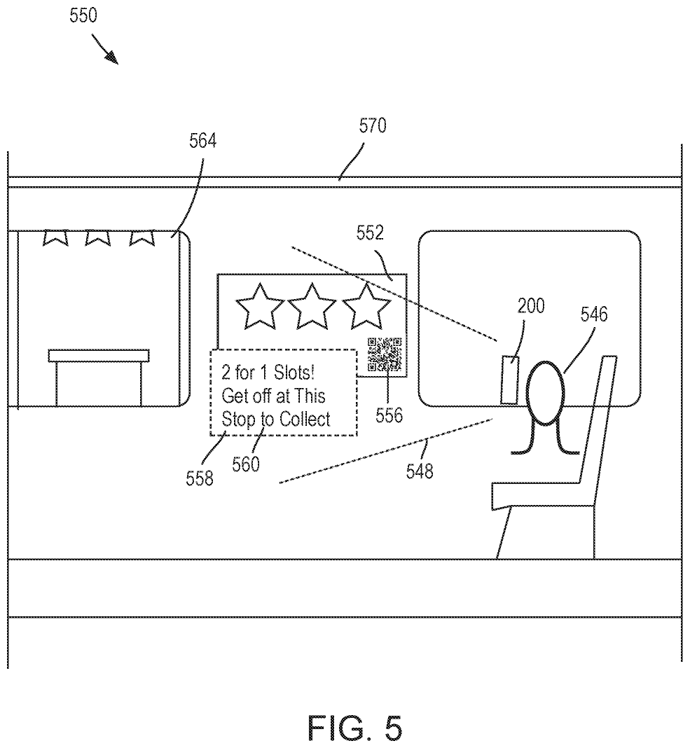

In this regard, FIG. 5 illustrates a mixed reality interface 550 including a vehicle 570, e.g., a bus in this example, within a scene 548 having a code 556 for providing virtual elements within the scene 548. In this example, a user 546 wearing a mixed reality viewer 200 on the bus 570 can see a code 556 on a sign 552, e.g., a printed advertisement or a digital sign, on the interior of the bus 570. Based on the determined location of the bus 570 (and/or the determined location of the user 546 riding the bus 570), determining the code data represented by the code 556 causes the mixed reality viewer 200 to provide virtual elements 558 that include information, such as an offer 560 associated with a casino 564 that is on the bus's 570 route. As the bus 570 approaches the casino 564 or other location, the mixed reality viewer 200 may determine the change in location, and the mixed reality interface 550 can change accordingly to reflect the proximity to the casino 564, such as by informing the user 446 to disembark the bus 570 at the next stop to redeem the offer 560 at the casino 564. It should be understood that embodiments disclosed herein may be adapted for use with any type of vehicle or other mode of transportation.

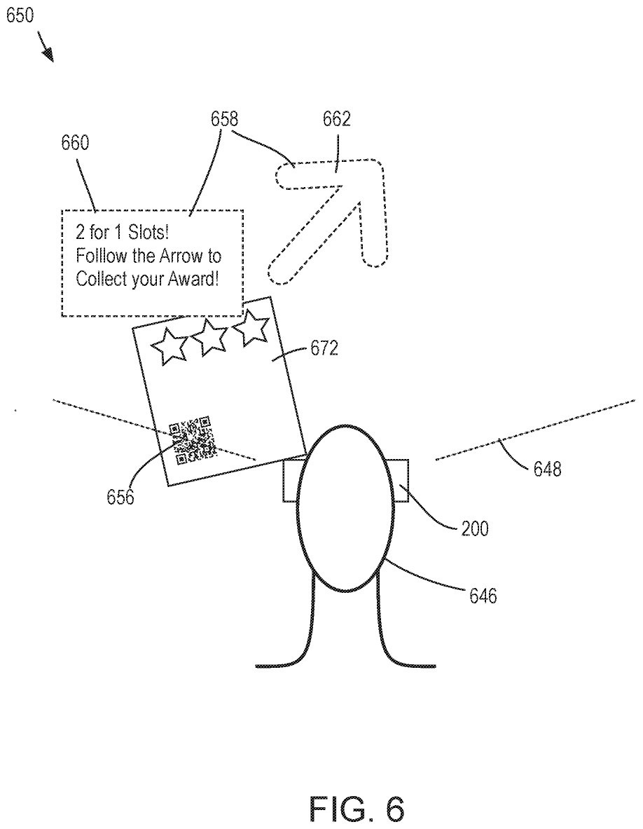

In another example, FIG. 6 illustrates a mixed reality interface 650 including a portable printed medium 672 within a scene 648 having a code 656 for providing virtual elements 658 to a user 646 viewing the scene 648. In this example, the portable printed medium 672 is a flyer, but it should be understood that the portable printed medium 672 may alternatively be a printed coupon, book or magazine advertisement, or other printed medium that not in a fixed and/or known geographic location. Based on viewing the code 656 in the portable printed medium 672 and determining a location of the user 646 viewing the scene 648 via the mixed reality viewer 200, virtual elements 658 such as offers 660 and/or directions 662 to a location may be displayed to the user 646 via the mixed reality interface 650. In some embodiments, the code 656 may be a personal code that is only available to be used by a specific user. For example, the code 656 could be part of a direct mail coupon that is sent only to the user. The code 656 could also be tied to the mixed reality viewer 200, so that the code 656 may only be used by a particular mixed reality viewer associated with a particular user. In other embodiments, the code 656 may be a group code, that is only available for a predetermined category or group of users.

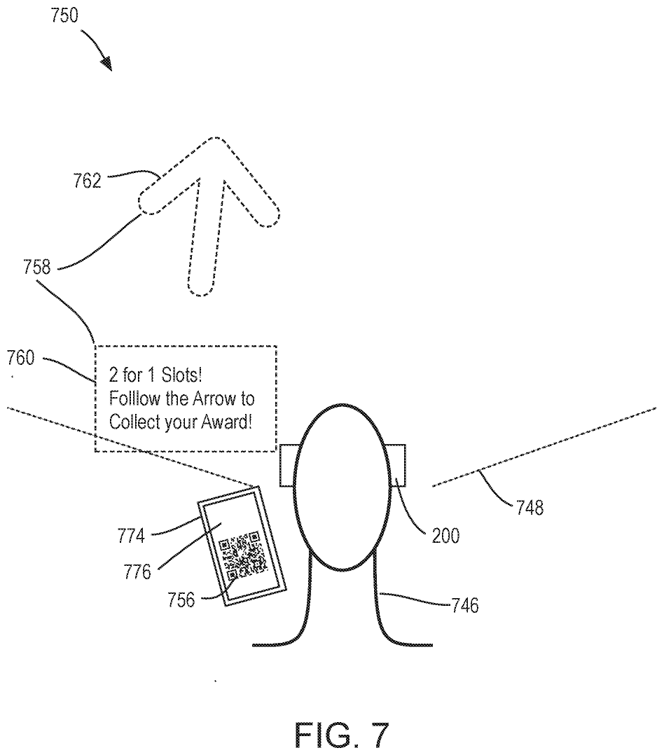

In another example, FIG. 7 illustrates a mixed reality interface 750 including a mobile device 774 within a scene 748 having a code 756 for providing virtual elements 758 to a user 746 viewing the scene 748. In this example, the mobile device 774 includes a display 776 for displaying the code 756 as part of application graphics, a web page, or other electronic display elements. Based on the code data for the code 756 and the location of the user 746 of the mobile device 774, virtual elements 758, such as an offer 760 or graphical elements 762, are displayed to the user 746 within the scene 748 as part of the mixed reality interface 750.

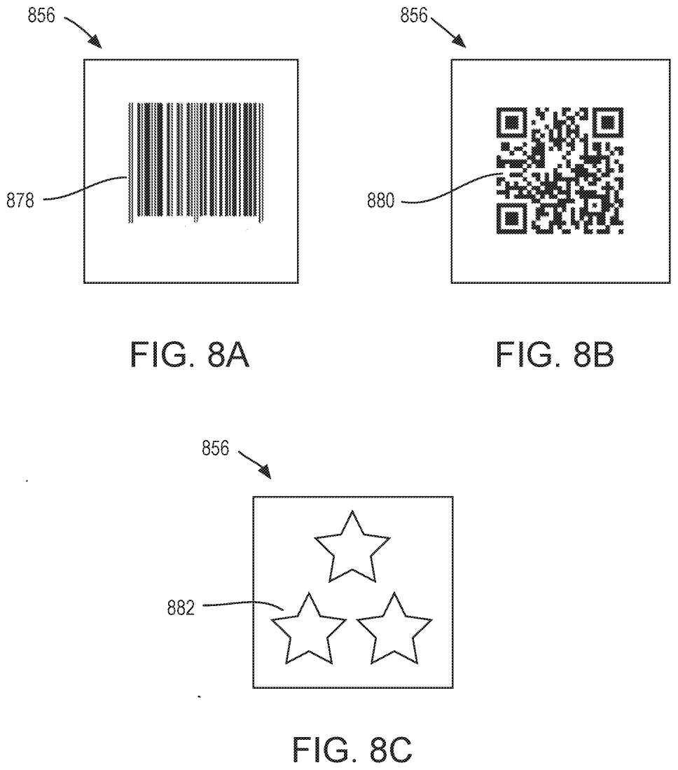

FIG. 8A-8C illustrate different examples of codes 856 for providing virtual elements within a mixed reality interface, according to different embodiments. In the example of FIG. 8A, the code 856 is a one-dimensional bar code (e.g., a UPC code) 878. In the example of FIG. 8B, the code 856 is a two-dimensional matrix barcode (e.g., a QR code) 880. In the example of FIG. 8C, the code 856 is a graphical design 882, which may be logo or a trademark associated with the offer 860, for example. It should be understood that these and other optical, machine-readable codes may have different appearances, as desired.

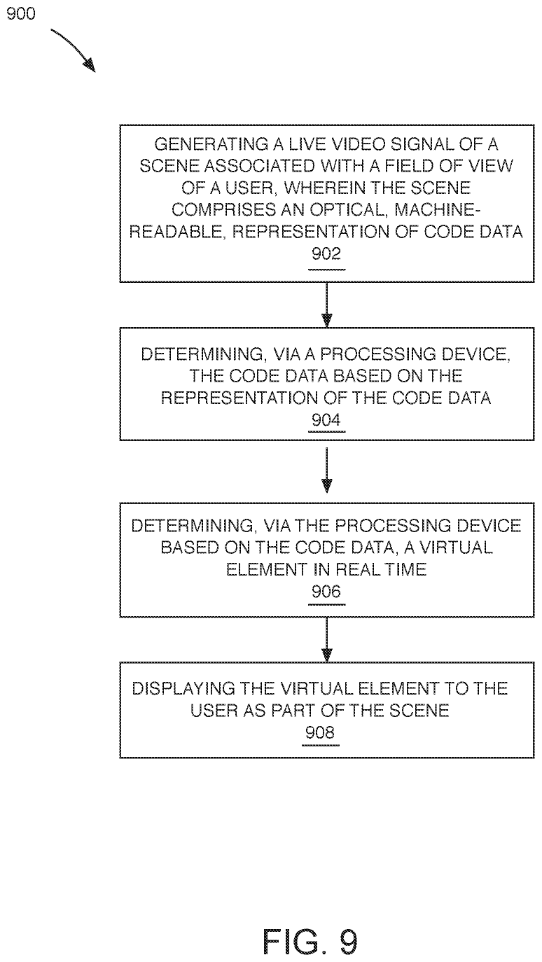

Referring now to FIG. 9, a flowchart diagram illustrates operations of a method 900 according to some embodiments. The method 900 includes generating a live video signal of a scene associated with a field of view of a user, wherein the scene comprises an optical, machine-readable, representation of code data (Block 902). The method 900 further includes determining, via a processing device, the code data based on the representation of the code data (Block 904). The method 900 further includes determining, via the processing device based on the code data, a virtual element in real time (Block 906). The method 900 further includes displaying the virtual element to the user as part of the scene (Block 908).

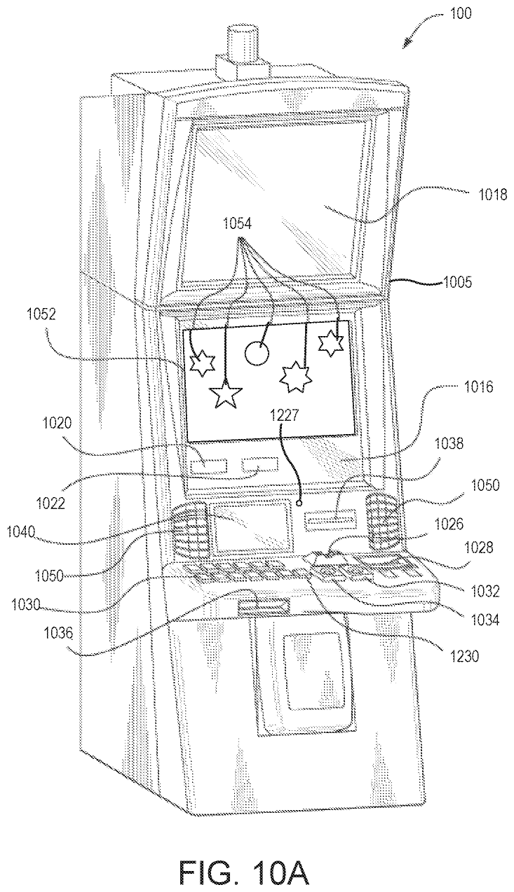

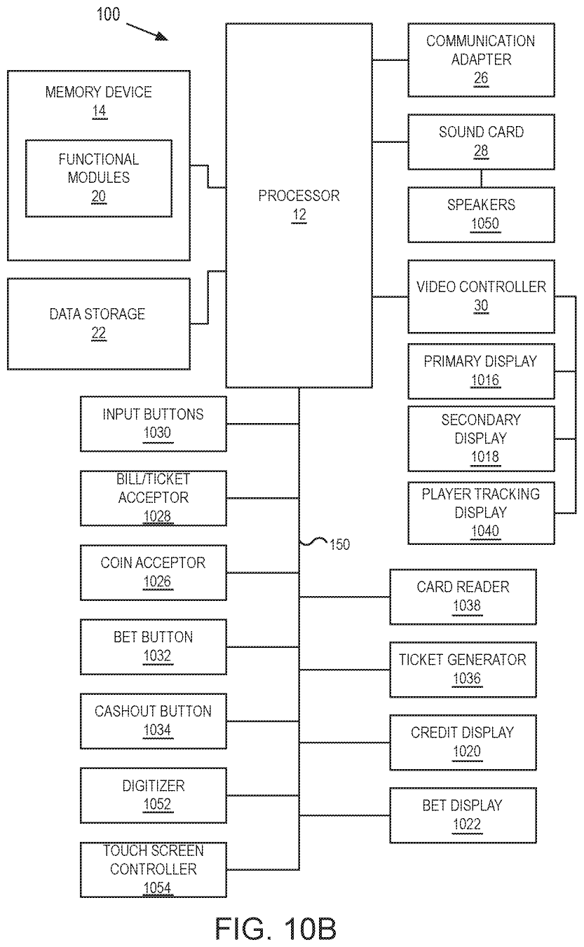

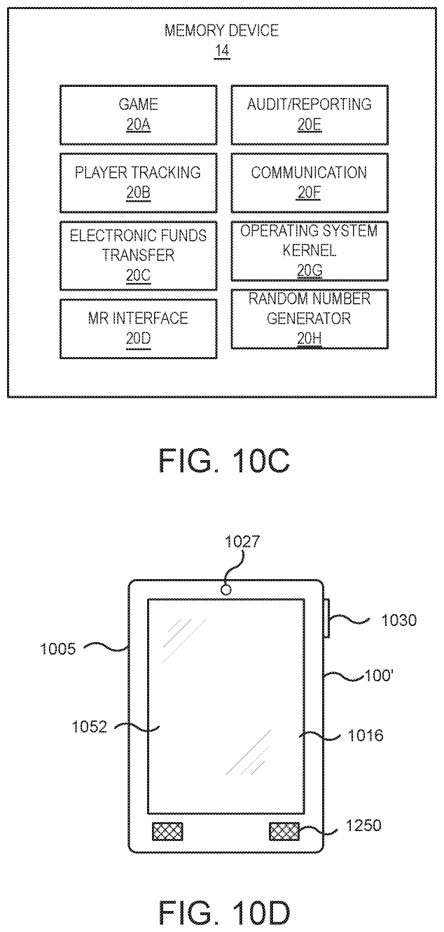

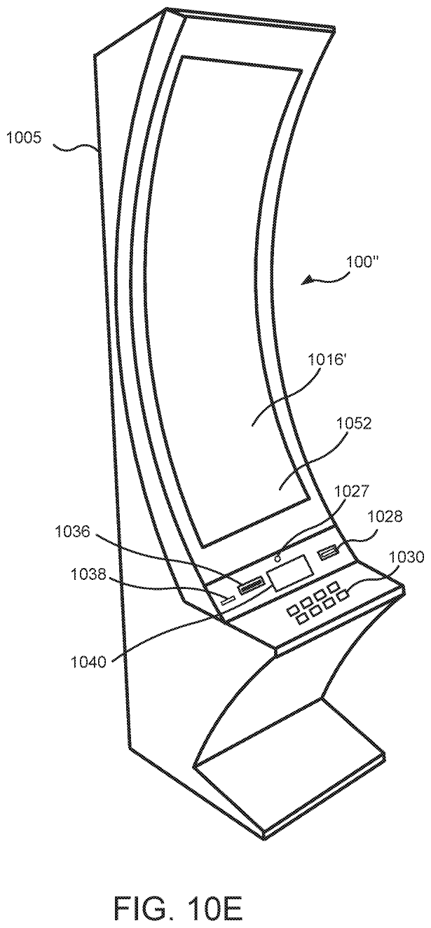

In some embodiments, various offers and other virtual elements may be redeemable and/or interactively related to EGMs, other types of gaming machines, or other types of casino games, products, or services. In this regard, an example of an electronic gaming machine (EGM) that can interact with mixed reality viewers according to various embodiments is illustrated in FIGS. 10A, 10B, and 10C in which FIG. 10A is a perspective view of an EGM 100 illustrating various physical features of the device, FIG. 10B is a functional block diagram that schematically illustrates an electronic relationship of various elements of the EGM 100, and FIG. 10C illustrates various functional modules that can be stored in a memory device of the EGM 100. The embodiments shown in FIGS. 10A to 10C are provided as examples for illustrative purposes only. It will be appreciated that EGMs may come in many different shapes, sizes, layouts, form factors, and configurations, and with varying numbers and types of input and output devices, and that embodiments of the inventive concepts are not limited to the particular EGM structures described herein.

EGMs may include a number of standard features, many of which are illustrated in FIGS. 10A and 10B. For example, referring to FIG. 10A, an EGM 100 may include a support structure, housing or cabinet 1005 which provides support for a plurality of displays, inputs, outputs, controls and other features that enable a player to interact with the EGM 100.

The EGM 100 illustrated in FIG. 10A includes a number of display devices, including a primary display device 1016 located in a central portion of the cabinet 1005 and a secondary display device 1018 located in an upper portion of the cabinet 1005. It will be appreciated that one or more of the display devices 1016, 1018 may be omitted, or that the display devices 1016, 1018 may be combined into a single display device. The EGM 100 may further include a player tracking display 1040, a credit display 1020, and a bet display 1022. The credit display 1020 displays a player's current number of credits, cash, account balance or the equivalent. The bet display 1022 displays a player's amount wagered.

The player tracking display 1040 may be used to display a service window that allows the player to interact with, for example, their player loyalty account to obtain features, bonuses, comps, etc. In other embodiments, additional display screens may be provided beyond those illustrated in FIG. 10A. In some embodiments, a player's account or another account may be used to track usage of codes such as the codes disclosed herein and to generate new codes based on analysis of code usage by the player and/or other users.

The EGM 100 may further include a number of input devices that allow a player to provide various inputs to the EGM 100, either before, during or after a game has been played. For example, the EGM 100 may include a plurality of input buttons 1030 that allow the player to select options before, during or after game play. The EGM may further include a game play initiation button 1032 and a cashout button 1034. The cashout button 1034 is utilized to receive a cash payment or any other suitable form of payment corresponding to a quantity of remaining credits of a credit display.

In some embodiments, one or more input devices of the EGM 100 are one or more game play activation devices that are each used to initiate a play of a game on the EGM 100 or a sequence of events associated with the EGM 100 following appropriate funding of the EGM 100. The example EGM 100 illustrated in FIGS. 10A and 10B includes a game play activation device in the form of a game play initiation button 1032. It should be appreciated that, in other embodiments, the EGM 100 begins game play automatically upon appropriate funding rather than upon utilization of the game play activation device.

In some embodiments, one or more input devices of the EGM 100 are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one.

In some embodiments, one or more of the display screens may a touch-sensitive display that includes a digitizer 1052 and a touchscreen controller 1054 (FIG. 10B). The player may interact with the EGM 100 by touching virtual buttons on one or more of the display devices 1016, 1018, 1040. Accordingly, any of the above described input devices, such as the input buttons 1030, the game play initiation button 1032 and/or the cashout button 1034 may be provided as virtual buttons on one or more of the display devices 1016, 1018, 1040.

Referring briefly to FIG. 10B, operation of the primary display device 1016, the secondary display device 1018 and the player tracking display 1040 may be controlled by a video controller 30 that receives video data from a processor 12 or directly from a memory device 14 and displays the video data on the display screen. The credit display 1020 and the bet display 1022 are typically implemented as simple LCD or LED displays that display a number of credits available for wagering and a number of credits being wagered on a particular game. Accordingly, the credit display 1020 and the bet display 1022 may be driven directly by the processor 12. In some embodiments however, the credit display 1020 and/or the bet display 1022 may be driven by the video controller 30.

Referring again to FIG. 10A, the display devices 1016, 1018, 1040 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 1016, 1018, 1040 may include a touch-screen with an associated touch-screen controller 1054 and digitizer 1052. The display devices 1016, 1018, 1040 may be of any suitable size, shape, and/or configuration. The display devices 1016, 1018, 1040 may include flat or curved display surfaces.

The display devices 1016, 1018, 1040 and video controller 30 of the EGM 100 are generally configured to display one or more game and/or non-game images, symbols, and indicia. In certain embodiments, the display devices 1016, 1018, 1040 of the EGM 100 are configured to display any suitable visual representation or exhibition of the movement of objects; dynamic lighting; video images; images of people, characters, places, things, and faces of cards; and the like. In certain embodiments, the display devices 1016, 1018, 1040 of the EGM 100 are configured to display one or more virtual reels, one or more virtual wheels, and/or one or more virtual dice. In other embodiments, certain of the displayed images, symbols, and indicia are in mechanical form. That is, in these embodiments, the display device 1016, 1018, 1040 includes any electromechanical device, such as one or more rotatable wheels, one or more reels, and/or one or more dice, configured to display at least one or a plurality of game or other suitable images, symbols, or indicia.

The EGM 100 also includes various features that enable a player to deposit credits in the EGM 100 and withdraw credits from the EGM 100, such as in the form of a payout of winnings, credits, etc. For example, the EGM 100 may include a ticket dispenser 1036, a bill/ticket acceptor 1028, and a coin acceptor 1026 that allows the player to deposit coins into the EGM 100.

While not illustrated in FIG. 10A, the EGM 100 may also include a payment mechanism, which may include a coin and/or bill acceptor, a coin and/or bill dispenser, an electronic card reader including a magnetic and/or chip-based reader, and/or a wireless reader including a near-field communication (NFC), Bluetooth, Wi-Fi, or other type of wireless interface, for example.

The EGM 100 may further include one or more speakers 1050 controlled by one or more sound cards 28 (FIG. 10B). The EGM 100 illustrated in FIG. 10A includes a pair of speakers 1050. In other embodiments, additional speakers, such as surround sound speakers, may be provided within or on the cabinet 1005. Moreover, the EGM 100 may include built-in seating with integrated headrest speakers.

In various embodiments, the EGM 100 may generate dynamic sounds coupled with attractive multimedia images displayed on one or more of the display devices 1016, 1018, 1040 to provide an audio-visual representation or to otherwise display full-motion video with sound to attract players to the EGM 100 and/or to engage the player during gameplay. In certain embodiments, the EGM 100 may display a sequence of audio and/or visual attraction messages during idle periods to attract potential players to the EGM 100. The videos may be customized to provide any appropriate information.

The EGM 100 may further include a card reader 1038 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor determines the amount of funds entered and displays the corresponding amount on the credit or other suitable display as described above.

In some embodiments, the EGM 100 may include an electronic payout device or module configured to fund an electronically recordable identification card or smart card or a bank or other account via an electronic funds transfer to or from the EGM 100.

FIG. 10B is a block diagram that illustrates logical and functional relationships between various components of an EGM 100. As shown in FIG. 10B, the EGM 100 may include a processor 12 that controls operations of the EGM 100. Although illustrated as a single processor, multiple special purpose and/or general purpose processors and/or processor cores may be provided in the EGM 100. For example, the EGM 100 may include one or more of a video processor, a signal processor, a sound processor and/or a communication controller that performs one or more control functions within the EGM 100. The processor 12 may be variously referred to as a “controller,” “microcontroller,” “microprocessor” or simply a “computer.” The processor may further include one or more application-specific integrated circuits (ASICs).

Various components of the EGM 100 are illustrated in FIG. 10B as being connected to the processor 12. It will be appreciated that the components may be connected to the processor 12 through a system bus, a communication bus and controller, such as a USB controller and USB bus, a network interface, or any other suitable type of connection.

The EGM 100 further includes a memory device 14 that stores one or more functional modules 20. Various functional modules 20 of the EGM 100 will be described in more detail below in connection with FIG. 10D.

The memory device 14 may store program code and instructions, executable by the processor 12, to control the EGM 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The EGM 100 may further include a data storage device 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The EGM 100 may include a communication adapter 26 that enables the EGM 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the EGM 100 to communicate, for example, with a mobile communication device operated by a player.

The EGM 100 may include one or more internal or external communication ports that enable the processor 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor through a universal serial bus (USB) hub (not shown) connected to the processor 12.

In some embodiments, the EGM 100 may include a sensor, such as a camera 1227 in communication with the processor 12 (and possibly controlled by the processor 12) that is selectively positioned to acquire an image of a player actively using the EGM 100 and/or the surrounding area of the EGM 100. In one embodiment, the camera may be configured to selectively acquire still or moving (e.g., video) images and may be configured to acquire the images in either an analog, digital or other suitable format. The display devices 1016, 1018, 1040 may be configured to display the image acquired by the camera as well as display the visible manifestation of the game in split screen or picture-in-picture fashion. For example, the camera may acquire an image of the player and the processor 12 may incorporate that image into the primary and/or secondary game as a game image, symbol or indicia.

Various functional modules of that may be stored in a memory device 14 of an EGM 100 are illustrated in FIG. 10C. Referring to FIG. 10C, the EGM 100 may include in the memory device 14 a game module 20A that includes program instructions and/or data for operating a hybrid wagering game as described herein. The EGM 100 may further include a player tracking module 20B, an electronic funds transfer module 20C, a wide area progressive module 20D, an audit/reporting module 20E, a communication module 20F, an operating system 20G and a random number generator 20H. The player tracking module 20B keeps track of the play of a player. The electronic funds transfer module 20C communicates with a back end server or financial institution to transfer funds to and from an account associated with the player. The wide area progressive (WAP) interface module 20D interacts with a remote WAP server to enable the EGM 100 to participate in a wide area progressive jackpot game as described in more detail below. The communication module 20F enables the EGM 100 to communicate with remote servers and other EGMs using various secure communication interfaces. The operating system kernel 20G controls the overall operation of the EGM 100, including the loading and operation of other modules. The random number generator 20H generates random or pseudorandom numbers for use in the operation of the hybrid games described herein.

In some embodiments, an EGM 100 may be implemented by a desktop computer, a laptop personal computer, a personal digital assistant (PDA), portable computing device, or other computerized platform. In some embodiments, the EGM 100 may be operable over a wireless network, such as part of a wireless gaming system. In such embodiments, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 10D, an EGM 100′ may be implemented as a handheld device including a compact housing 1005 on which is mounted a touchscreen display device 1016 including a digitizer 1052. An input button 1030 may be provided on the housing and may act as a power or control button. A camera 1027 may be provided in a front face of the housing 1005. The housing 1005 may include one or more speakers 1050. In the EGM 100′, various input buttons described above, such as the cashout button, gameplay activation button, etc., may be implemented as soft buttons on the touchscreen display device 1016. Moreover, the EGM 100′ may omit certain features, such as a bill acceptor, a ticket generator, a coin acceptor or dispenser, a card reader, secondary displays, a bet display, a credit display, etc. Credits can be deposited in or transferred from the EGM 100′ electronically.

FIG. 10E illustrates a standalone EGM 100″ having a different form factor from the EGM 100 illustrated in FIG. 10A. In particular, the EGM 100″ is characterized by having a large, high aspect ratio, curved primary display device 1016′ provided in the housing 1005, with no secondary display device. The primary display device 1016′ may include a digitizer 1052 to allow touchscreen interaction with the primary display device 1016′. The EGM 1000″ may further include a player tracking display 1040, a plurality of input buttons 1030, a bill/ticket acceptor 1028, a card reader 1038, and a ticket generator 1036. The EGM 100″ may further include one or more cameras 1027 to enable facial recognition and/or motion tracking.

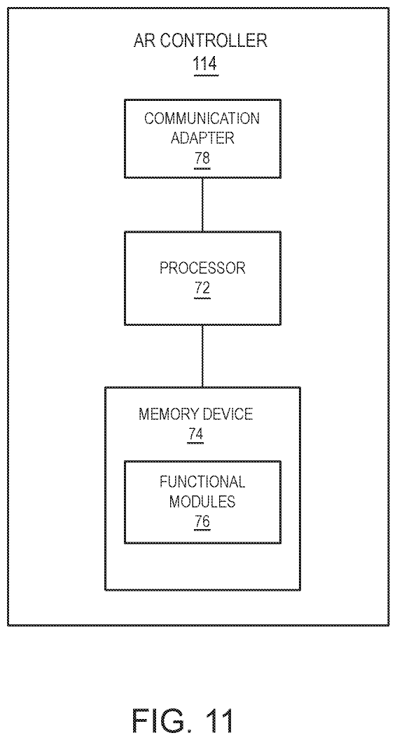

FIG. 11 is a block diagram that illustrates various components of an AR controller 114 according to some embodiment. As shown in FIG. 11, the AR controller 114 may include a processor 72 that controls operations of the AR controller 114. Although illustrated as a single processor, multiple special purpose and/or general purpose processors and/or processor cores may be provided in the AR controller 114. For example, the EGM 100 may include one or more of a video processor, a signal processor, a sound processor and/or a communication controller that performs one or more control functions within the EGM 100. The processor 72 may be variously referred to as a “controller,” “microcontroller,” “microprocessor” or simply a “computer.” The processor may further include one or more application-specific integrated circuits (ASICs).

Various components of the AR controller 114 are illustrated in FIG. 11 as being connected to the processor 72. It will be appreciated that the components may be connected to the processor 72 through a system bus, a communication bus and controller, such as a USB controller and USB bus, a network interface, or any other suitable type of connection.

The AR controller 114 further includes a memory device 74 that stores one or more functional modules 76 for performing the operations described above.

The memory device 74 may store program code and instructions, executable by the processor 72, to control the AR controller 114. The memory device 74 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The AR controller 114 may include a communication adapter 78 that enables the AR controller 114 to communicate with remote devices, such as EGMs 100 and/or a player tracking server 108 (FIG. 1) over a wired and/or wireless communication network, such as a local area network (LAN), wide area network (WAN), cellular communication network, or other data communication network.

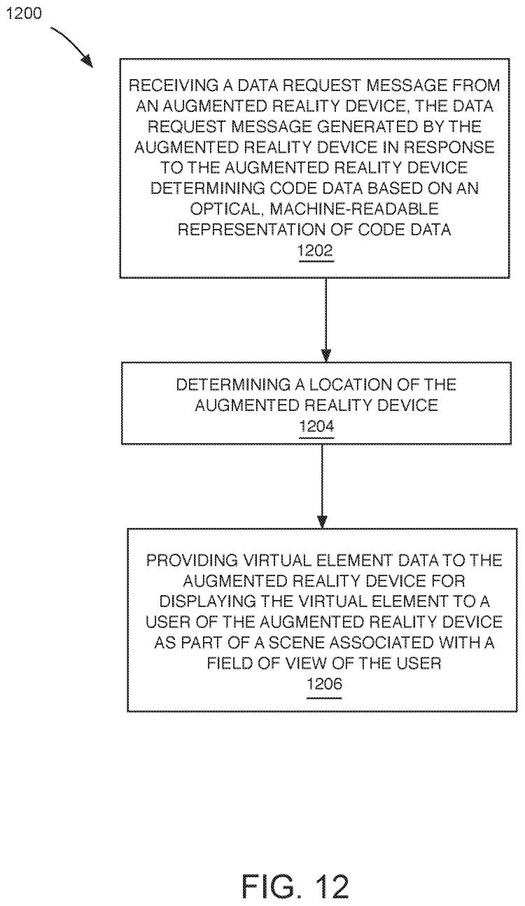

Referring now to FIG. 12, a flowchart diagram illustrates operations of a method 1200 according to some embodiments. The method 1200 includes receiving a data request message from an augmented reality device, the data request message generated by the augmented reality device in response to the augmented reality device determining code data based on an optical, machine-readable representation of code data (Block 1202). The method 1200 further includes determining a location of the augmented reality device (Block 1204). The method 1200 further includes providing virtual element data to the augmented reality device for displaying the virtual element to a user of the augmented reality device as part of a scene associated with a field of view of the user (Block 1206).

The EGM 100 disclosed herein may include one or more internal or external communication ports that enable the processor 72 to communicate with and to operate with internal or external peripheral devices, such as display screens, keypads, mass storage devices, microphones, speakers, and wireless communication devices. In some embodiments, internal or external peripheral devices may communicate with the processor through a universal serial bus (USB) hub (not shown) connected to the processor 72.

Embodiments described herein may be implemented in various configurations for EGMs 100s, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to an EGM local processor and memory devices. In such a “thick client” embodiment, the EGM local processor executes the communicated computerized instructions to control any games (or other suitable interfaces) provided to a player.

In some embodiments, an EGM may be operated by a mobile device, such as a mobile telephone, tablet other mobile computing device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with a machine readable instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A method comprising:
generating a live video signal of a scene associated with a field of view of a user, wherein the scene comprises a graphical design
determining, via a processor circuit based on the graphical design, a virtual element in real time; and
displaying, by a display device of a mixed reality display device associated with the user, the virtual element to the user as part of the scene.

2. The method of claim 1, wherein the scene further comprises an optical, machine-readable representation of code data, wherein determining the virtual element is further based on:
determining, via the processor circuit, the code data based on the representation of the code data; and
determining the virtual element further based on the code data.

3. The method of claim 1, wherein the graphical design further comprises a graphical logo associated with the virtual element.

4. The method of claim 1, wherein determining the virtual element further comprises:
determining, via the processor circuit, a location of the user; and
determining, via the processor circuit based on the graphical design and the location of the user, the virtual element in real time.

5. The method of claim 4, wherein determining the location of the user comprises:
determining, via the processor circuit, location information for a user device.

6. The method of claim 4, wherein determining the location of the user comprises:
determining, based on the live video signal, a location of the scene.

7. The method of claim 1, wherein the graphical design comprises a static graphical design within the scene.

8. The method of claim 7, wherein the static graphical design is affixed to a stationary sign at a fixed geographic location within the scene.

9. The method of claim 1, wherein the graphical design comprises an animated graphical design being displayed on a second display device within the scene.

10. The method of claim 9, wherein the second display device is affixed to a vehicle within the scene.

11. The method of claim 7, wherein the static graphical design is affixed to a portable printed medium within the scene.

12. The method of claim 9, wherein the second display device comprises a mobile display device associated with the user within the scene.

13. The method of claim 9, wherein the second display device comprises a digital sign at a fixed geographic location within the scene.

14. The method of claim 3, wherein the graphical logo is associated with a casino, and wherein the virtual element comprises an indication of a benefit associated with visiting the casino.

15. The method of claim 3, wherein the graphical logo is associated with a casino, and wherein the virtual element is an indication directing the user toward the casino.

16. A mixed reality device comprising:
a mixed reality display device;
a video capture device;
a processor; and
a memory coupled to the processor, the memory comprising machine-readable instructions operable to cause the processor to:
generate, via the video capture device, a live video signal of a scene associated with a field of view of a user, wherein the scene comprises an animated graphical design being displayed on a second display device within the scene;
determine, based on the animated graphical design, a virtual element in real time; and
display, via the mixed reality display device, the virtual element to the user as part of the scene.

17. A method comprising:
receiving a data request message from a mixed reality device, the data request message generated by the mixed reality device in response to the mixed reality device capturing an image of a graphical design within a scene;
determining, by a processor circuit, a location of the mixed reality device; and
providing virtual element data to the mixed reality device for displaying a virtual element to a user of the mixed reality device as part of a scene associated with a field of view of the user,
wherein the virtual element comprises an indication of a benefit associated with visiting a casino.

18. The method of claim 17, further comprising determining, by the processor circuit, an identity of a user of the mixed reality device,
wherein providing the virtual element data to the mixed reality device is based on the location of the mixed reality device and the identity of the user.

19. The method of claim 17, wherein the indication of the benefit further comprises an indication of a wagering benefit associated with a wagering game at the casino.

20. The method of claim 18, wherein the second display device comprises a digital sign at a fixed geographic location within the scene.
